(19) United States
(12) Patent Application Publication
(10) Pub. No.: US 2007/0104426 A1
(43) Pub. Date: May 10, 2007

(54) Bi-directional optical transceiver

(75) Inventors: In-Kuk Yun, Suwon-si (KR); Joong-Wan Park, Suwon-si (KR); Dong-Hoon Jang, Suwon-si (KR); Yun-Kyung Oh, Seoul (KR); Joong-Hee Lee, Seongnam-si (KR); Jeong-Seok Lee, Anyang-si (KR); Yu-Dong Bae, Suwon-si (KR); Jeong-Hwan Song, Seoul (KR); Jin-Wook Kwon, Suwon-si (KR); Do-Young Rhee, Yongin-si (KR); Ja-Won Seo, Suwon-si (KR); Seung-Woo Kim, Anyang-si (KR); Man-Ho Kim, Danwon-gu (KR); Seong-Min Seo, Yongin-si (KR)

Correspondence Address: CHA & REITER, LLC, 210 ROUTE 4 EAST STE 103, PARAMUS, NJ, 07652, US

(73) Assignee: Samsung Electronics Co.; LTD

(21) Appl. No.: 11/528,113

(22) Filed: Sep. 27, 2006

(30) Foreign Application Priority Data
Nov. 10, 2005 (KR) 107517/2005

(51) Int. Cl. G02B 6/36

(52) U.S. Cl. 385/88; 385/47; 385/49; 385/89; 398/141

(57) ABSTRACT

A bi-directional optical transceiver includes: an optical fiber for transmitting and receiving first and second optical signals; a transmitter module for generating the first optical signal; a receiver module for detecting the second optical signal; a tap filter for splitting a portion of the first optical signal; a monitor module for monitoring the magnitude of the portion of the first optical signal split by the tap filter; and a wavelength selection filter, which is located between the tap filter and the optical fiber, inputs the first optical signal output from the tap filter into the optical fiber, and inputs the second optical signal output from the optical fiber into an optical detector.

### CLAIM OF PRIORITY

This application claims priority under 35 U.S.C. § 119 to an application entitled “Bi-directional Optical Transceiver,” filed in the Korean Intellectual Property Office on Nov. 10, 2005 and assigned Serial No. 2005-107517, the contents of which are incorporated herein by reference.

### BACKGROUND OF THE INVENTION

1. Field of the Invention

The present invention relates generally to a bi-directional optical transceiver module, and in particular, to an optical transceiver module including a reflective semiconductor light source.

2. Description of the Related Art

Optical communication networks have become available on the market as a means for quickly and securely providing bulk information to a plurality of subscribers. In recent optical communication networks, Fiber To The Home (FTTH) for providing a communication service to home of each of subscribers has been popularized. In particular, a wavelength division multiplexing passive optical network (WDM-PON) is capable of providing bulk data to each subscriber with high security by assigning an unique wavelength to each subscriber.

FIG. 1 is a block diagram of a conventional bi-directional optical transceiver 100 according to the prior art. As shown, the conventional bi-directional optical transceiver 100 includes a wavelength selection filter 150 for splitting first and second optical signals, a semiconductor light source 110 for generating the first optical signal, an optical detector 130 for detecting the second optical signal, a monitoring optical detector 140 for monitoring the magnitude of the first optical signal, first to third lens systems 101, 102, and 103, and an optical fiber 120.

A reflective semiconductor optical amplifier used in a wavelength locking method includes a front surface coated with a non-reflective layer and a rear surface is coated with a high reflective layer. Alternatively, a Febry-Perot laser can be used for the semiconductor light source 110. A photo diode can be used for the monitoring optical detector 140, which detects the magnitude of some light that has passed the high reflective layer, and can estimate the magnitude of the first optical signal from the detection.

The first lens system 101 is located between the semiconductor light source 110 and the wavelength selection filter 150, collimates the first optical signal generated by the semiconductor light source 110, and inputs the collimated first optical signal to the wavelength selection filter 150. The third lens system 103 is located between the optical fiber 120 and the wavelength selection filter 150, converges the first optical signal into one end of the optical fiber 120, collimates the second optical signal output from the optical fiber 120, and inputs the collimated second optical signal to the wavelength selection filter 150.

The second lens system 102 is located between the wavelength selection filter 150 and the optical detector 130 and converges the second optical signal reflected by the wavelength selection filter 150 into the optical detector 130.

However, wavelength-locking light sources have a problem in that a ratio of the intensities of light output from the front and rear surfaces does not have a linearly proportional correlation according to the intensity of light input from the outside to induce a wavelength-locking optical signal. That is, due to a difference between asymmetrical reflection ratios of the high reflective layer and the non-reflective layer of the conventional light source, the magnitude of the first optical signal cannot be correctly monitored from the intensity of light passing through the high reflective layer.

### SUMMARY OF THE INVENTION

Accordingly, the present invention provides a bi-directional optical transceiver module for correctly monitoring the magnitude of an optical signal generated by a wavelength locking semiconductor light source.

Further, the present invention provides a miniaturized bi-directional optical transceiver module.

In one embodiment, there is provided a bi-directional optical transceiver comprising: an optical fiber for transmitting and receiving first and second optical signals; a transmitter module for generating the first optical signal; a receiver module for detecting the second optical signal; a tap filter for splitting a portion of the first optical signal; a monitor module for monitoring the magnitude of the portion of the first optical signal split by the tap filter; and a wavelength selection filter, which is located between the tap filter and the optical fiber, inputs the first optical signal output from the tap filter into the optical fiber, and inputs the second optical signal output from the optical fiber into an optical detector.

### BRIEF DESCRIPTION OF THE DRAWINGS

The above features and advantages of the present invention will become more apparent from the following detailed description when taken in conjunction with the accompanying drawings in which:

FIG. 1 is a block diagram of a conventional bi-directional optical transceiver according to the prior art;

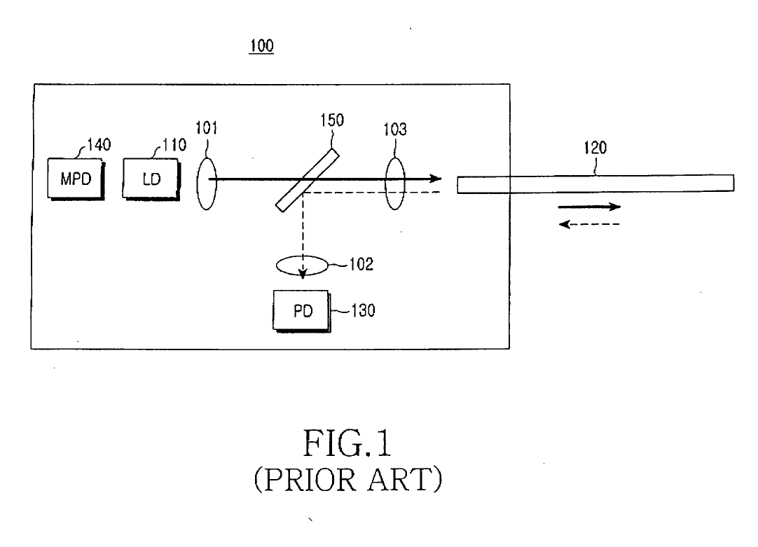

FIG. 2 is a cross-sectional view of a bi-directional optical transceiver according to an embodiment of the present invention;

FIG. 3 is an exploded perspective view of the bi-directional optical transceiver of FIG. 2;

FIGS. 4A to 4C are a cross-sectional view, a plan view, and a perspective view of a filter supporting member of FIG. 2;

FIGS. 5A and 5B are a perspective view and a cross-sectional view of a housing of FIG. 2; and

FIGS. 6A and 6B are diagrams for explaining the variation of a current of an optical signal detected by a monitor module according to the variation of temperature in accordance with an embodiment of the present invention.

### DETAILED DESCRIPTION

Now, embodiments of the present invention will be described herein below with reference to the accompanying drawings. For the purposes of clarity and simplicity, well-known functions or constructions are not described in detail as they would obscure the invention in unnecessary detail.

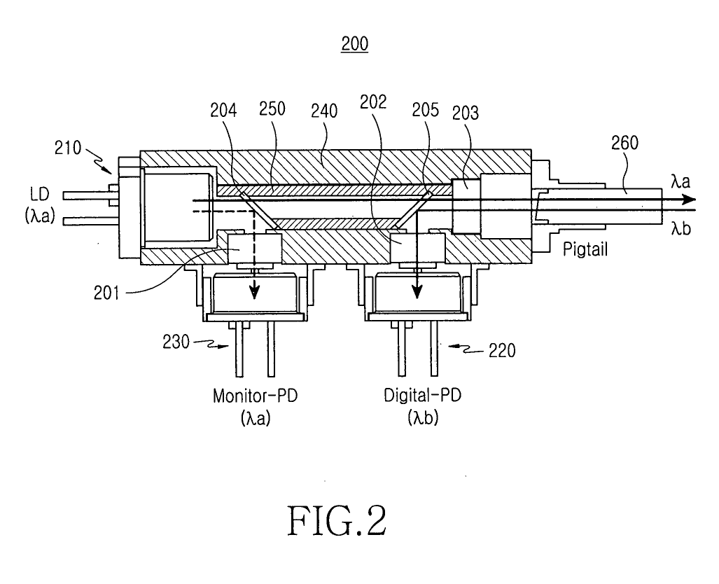

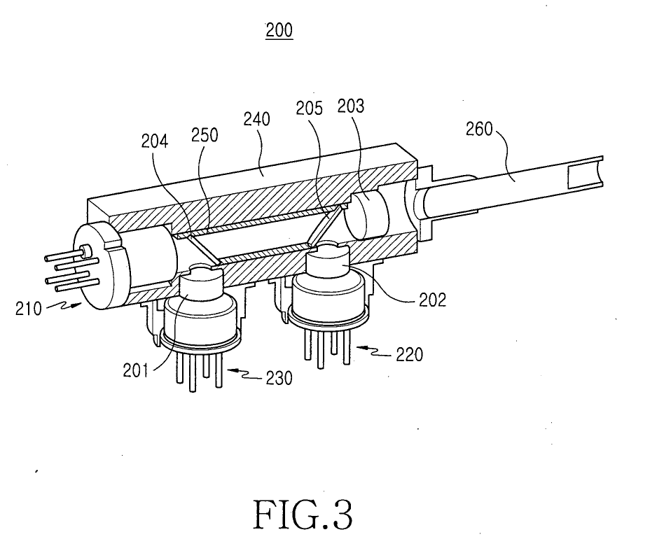

FIG. 2 is a cross-sectional view of a bi-directional optical transceiver 200 according to an embodiment of the present invention. FIG. 3 is an exploded perspective view of the bi-directional optical transceiver 200 of FIG. 2.

Referring to FIGS. 2 and 3, the bi-directional optical transceiver 200 includes an optical fiber 260 for transmitting and receiving first and second optical signals λₐ and λ_{b}, a transmitter module 210 for generating the first optical signal λₐ, a receiver module 220 for detecting the second optical signal λ_{b}, a tap filter 204 for splitting a portion (dotted arrow) of the first optical signal λₐ, a monitor module 230 for monitoring the magnitude of the first optical signal portion split by the tap filter 204, a wavelength selection filter 205 located between the tap filter 204 and the optical fiber 260, first to third lens systems 201, 202, and 203, a housing 240, and a filter supporting member 250.

The transmitter, receiver, and monitor modules 210, 220, and 230 have a TO-CAN structure, wherein the transmitter module 210 is inserted into a relevant hole of the housing 240, and the receiver and monitor modules 220 and 230 are located in parallel at the side of the housing 240 that can be applied to small-form-factor (SFF) or small-form-factor-pluggable (SFP).

The transmitter module 210 includes a light source for generating the first optical signal λₐ. For the light source, a semiconductor light source can be used, wherein one surface from which the first optical signal λₐ is output and of which a non-reflective layer is coated on, and the other surface of which a high reflective layer is coated on. Furthermore, for the semiconductor light source, a reflective semiconductor optical amplifier, which can be used in a wavelength-locking method, or a Febry-Perot laser can be used.

Each of the receiver and monitor modules 220 and 230 is an optical detection device, i.e., a photo diode and can detect an optical signal having a relevant wavelength.

The tap filter 204 and the wavelength selection filter 205 are located to have a slope of predetermined degrees from a certain normal line perpendicular to the traveling path of the first optical signal λₐ, thereby more effectively splitting a portion of the first optical signal λₐ, or changing the path of the second optical signal λ_{b} in a desired direction. The tap filter 204 splits a portion of the first optical signal λₐ generated by the transmitter module 210 and inputs the split first optical signal λₐ into the monitor module 230. The tap filter 204 is an edge type having an angle of incidence of 45° and may use a filter for passing 95% of the input first optical signal λₐ to the wavelength selection filter 205 and for reflecting the remaining 5% of the input first optical signal λₐ to the monitor module 230.

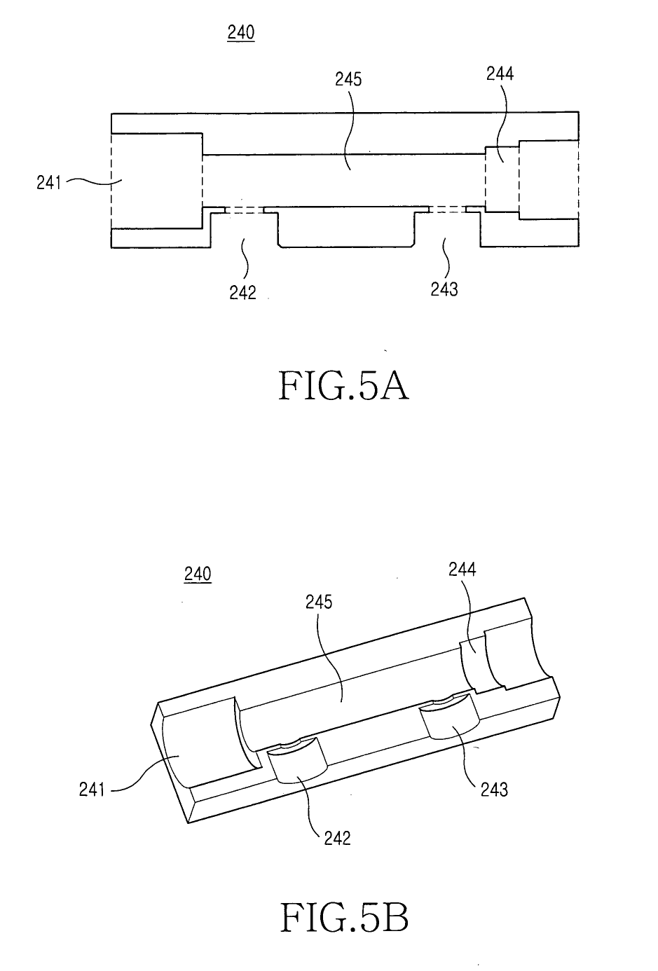

Referring to FIGS. 5A and 5B, at the both ends of the housing 240, one end of the transmitter module 210 and one end of the optical fiber 260 are inserted to face each other. The filter supporting member 250 has a hollow cylindrical shape and is inserted into a hollow portion 245 of the housing 240 to allow the first optical signal λₐ to travel.

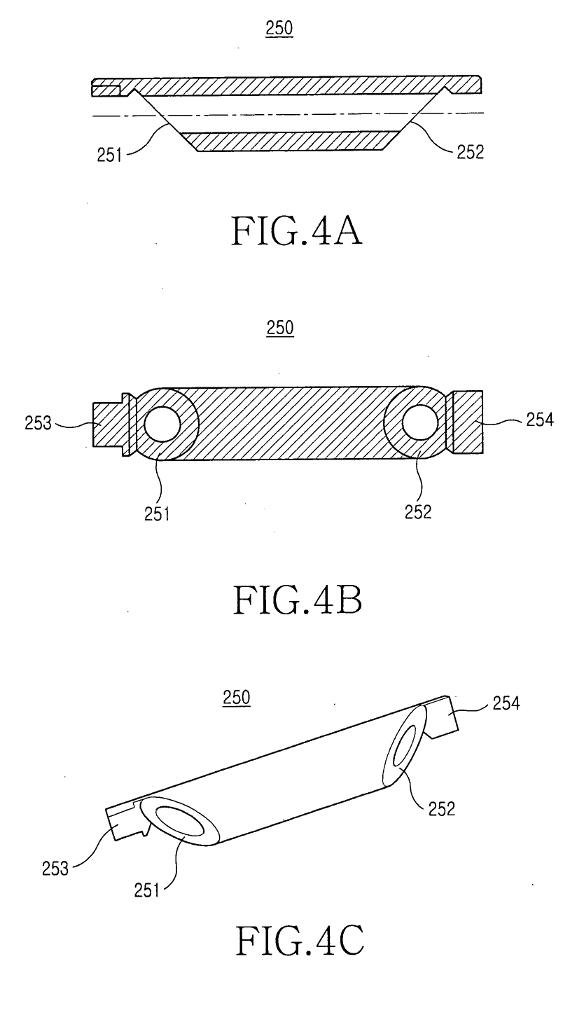

FIGS. 4A to 4C are a cross-sectional view, a plan view, and a perspective view of the filter supporting member 250 shown in FIG. 2. As shown, the filter supporting member 250 includes a first surface 251 facing the transmitter module 210, a second surface 252 facing the optical fiber 260, and arrangement keys 253 and 254 extended from the both ends. The tap filter 204 is fixed to the first surface 251 so that the incident surface of the tap filter 204 has a slope of predetermined degrees from the traveling path of the first optical signal λₐ, and the wavelength selection filter 205 is fixed to the second surface 252. The arrangement keys 253 and 254 are extended from the first and second surfaces 251 and 252, and v-shaped grooves can be formed to fix the tap filter 204 and the wavelength selection filter 205 in the boundary portions between the arrangement keys 253 and 254 and the first and second surfaces 251 and 252.

The first lens system 201 converges the first optical signal λₐ split by the tap filter 204 into the monitor module 230, and the second lens system 202 converges the second optical signal 4 reflected by the wavelength selection filter 205 into the receiver module 220. The third lens system 203 converges the first optical signal λₐ into one end of the optical fiber 260, collimates the second optical signal λ_{b}, and outputs the collimated second optical signal λ_{b} to the wavelength selection filter 205. The first to third lens systems 201, 202, and 203 may use a non-spherical lens. The first to third lens systems 201, 202, and 203 are inserted into relevant holes 242, 243, and 244 of the housing 240.

The optical fiber 260 is located at the opposite end of a hole 241 into which the transmitter module 210 is inserted, outputs the first optical signal λₐ to the outside of the bi-directional optical transceiver 200, and outputs the second optical signal λ_{b}, which is input from the outside of the bi-directional optical transceiver 200, to the wavelength selection filter 205. The optical fiber 260 may have a slope of 8° from a certain normal line perpendicular to the traveling path of the first and second optical signals λₐ and λₐ in order to minimize a coupling loss due to the reflection at one end thereof through which optical signals are input/output.

The wavelength selection filter 205 is located between the optical fiber 260 and the tap filter 204, outputs the first optical signal λₐ, which is input from the tap filter 204, to the optical fiber 260, and reflects the second optical signal λ_{b}, which is input from the optical fiber 260, to the receiver module 220.

The monitor module 230 can include a photo diode for detecting the first optical signal λₐ split by the tap filter 204.

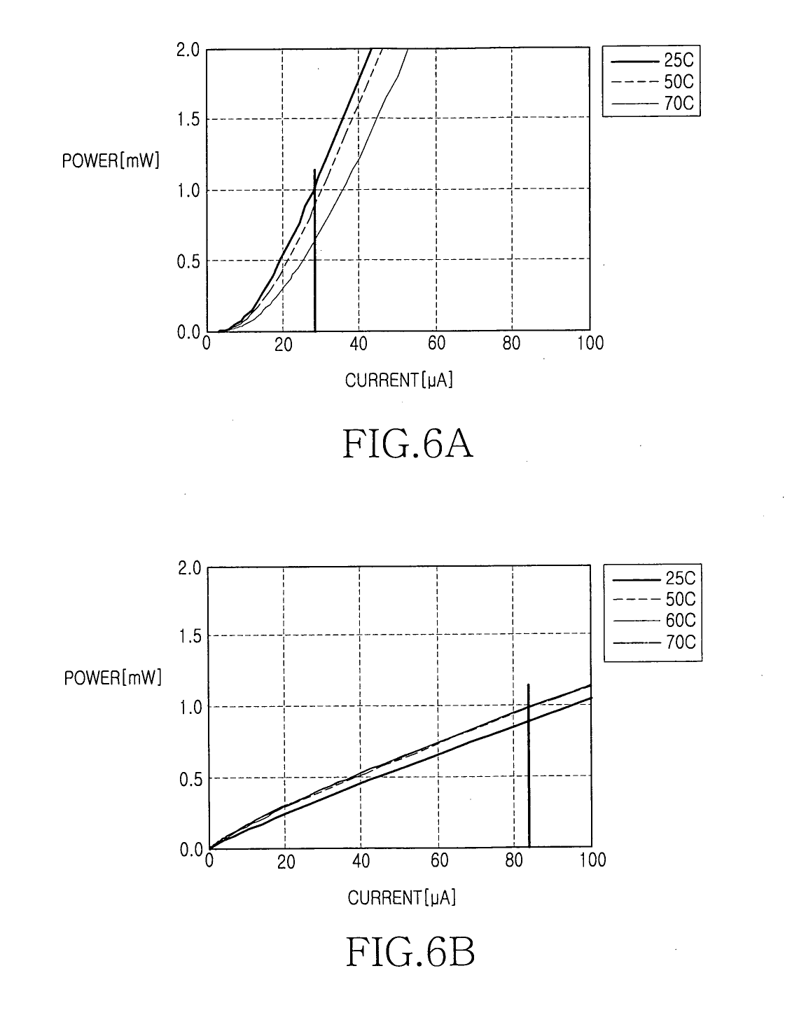

FIGS. 6A and 6B are diagrams for explaining the variation of power of the first optical signal λₐ according to the variation of a current of an optical signal detected by the monitor module 230 with respect to the variation of temperature in accordance with the embodiment of the present invention.

In particular, FIG. 6A is a diagram for explaining the variation of power of the first optical signal λₐ according to the variation of a current of a rear-surface-monitored optical signal with respect to the variation of temperature according to the prior art. FIG. 6B is a diagram for explaining the variation of power of the first optical signal λₐ according to the variation of a current of a front-surface-monitored optical signal with respect to the variation of temperature according to the embodiment of the present invention.

If it is assumed that the detected current is 28 μA (the bold solid line parallel to the y-axis) in FIG. 6A, FIG. 6A shows a difference of around 1.9 dB between the power of the first optical signal λₐ at 25° C. and the power of the first optical signal λₐ at 70° C. If it is assumed that the detect current is 83 μA (the bold solid line parallel to the y-axis) in FIG. 6B, FIG. 6B shows a difference of around 0.41 dB between the power of the first optical signal λₐ at 25° C. and the power of the first optical signal λₐ at 70° C.

In FIGS. 6A and 6B, the power can be transformed to dB using “power variation (dB)=10×log₁₀ (comparison power/reference power).” That is, in FIG. 6A, the power variation can be calculated by 1.938 dB=10 log₁₀(0.63 mW/1 mW). The reference power denotes power at the lowest temperature, i.e., 25° C., among the tested temperatures, and the comparison power denotes power at 70° C. under the same conditions. In FIG. 6B, the power variation can be calculated in the same method. That is, in FIG. 6B, the power variation can be calculated by 0.4096 dB=10 log₁₀(0.91 mW/1 mW).

As a result, according to the embodiment of the present invention, by monitoring the variation of the magnitude of an optical signal obtained by splitting a portion of an output optical signal, the variation of a characteristic of the optical signal can be stably monitored even if the variation of temperature occurs. Accordingly, a bi-directional optical transceiver can correctly monitor the magnitude of a wavelength-locking optical signal regardless of the intensity of light input to induce the wavelength locking. In addition, the bi-directional optical transceiver can be applied as a miniaturized SFF or SFP type by placing monitor and receiver modules adjacently in parallel.

While the invention has been shown and described with reference to a certain preferred embodiment thereof, it will be understood by those skilled in the art that various changes in form and details may be made therein without departing from the spirit and scope of the invention as defined by the appended claims.

What is claimed is:

1. A bi-directional optical transceiver comprising:
an optical fiber for transmitting and receiving first and second optical signals;
a transmitter module for generating the first optical signal;
a receiver module for detecting the second optical signal;
a tap filter for splitting a portion of the first optical signal;
a monitor module for monitoring the magnitude of the first optical signal split by the tap filter; and
a wavelength selection filter disposed between the tap filter and the optical fiber for inputting the first optical signal from the tap filter into the optical fiber and the second optical signal from the optical fiber into an optical detector.

2. The bi-directional optical transceiver of claim 1, further comprising:
a housing coupled to one end of the transmitter module and one end of the optical fiber and having a hollow portion perforated therebetween; and
a filter supporting member being inserted into the hollow portion so that the first optical signal can travel a first surface coupled to the tap filter facing the transmitter module and a second surface coupled to the wavelength selection filter facing the optical fiber.

3. The bi-directional optical transceiver of claim 2, wherein the first surface has a slope of predetermined degrees from a normal line perpendicular to the traveling path of the first optical signal.

4. The bi-directional optical transceiver of claim 2, wherein the second surface has a slope of predetermined degrees from a normal line perpendicular to the traveling path of the first optical signal.

5. The bi-directional optical transceiver of claim 2, wherein top surfaces of both ends of the filter supporting member comprise grooves formed to adjust slopes of the filters.

6. The bi-directional optical transceiver of claim 2, wherein the housing comprises an empty cylindrical shape.

7. The bi-directional optical transceiver of 1, wherein the monitoring module is a photo diode.

8. The bi-directional optical transceiver of 1, wherein the tap filter is an edge type having an angle of incidence of 45°.

9. The bi-directional optical transceiver of 1, wherein the tap filter is configured to pass 95% of the input first optical signal and to reflect the remaining 5% of the input first optical signal to the monitor module.

10. The bi-directional optical transceiver of 1, wherein the optical fiber comprises a slope of 8° from a normal line perpendicular to the traveling path of the first and second optical signals

11. The bi-directional optical transceiver of 1, wherein the monitor module is a photo diode for detecting the first optical signal.
